(19) United States
(12) Patent Application Publication
(10) Pub. No.: US 2003/0041024 A1
(43) Pub. Date: Feb. 27, 2003

(54) System for managing inter-company settlement and the method therefor

(76) Inventor: Dong Lyun Yim, Seoul (KR)

Correspondence Address: DICKSTEIN SHAPIRO MORIN & OSHINSKY LLP, 2101 L STREET NW, WASHINGTON, DC, 20037-1526, US

(21) Appl. No.: 10/220,765

(22) PCT Filed: Mar. 9, 2001
(86) PCT No.: PCT/KR01/00369

(30) Foreign Application Priority Data
Mar. 10, 2000 (KR) 2000/12000
Mar. 5, 2001 (KR) 2001/11094

(51) Int. Cl. G06F 17/60

(52) U.S. Cl. 705/39

(57) ABSTRACT

The present invention relates to a system for managing the inter-company settlement and the method therefor. The present invention, by implementing, on the bank on-line network, the overall settlement procedure that selling companies and purchasing companies take for transactions, enables such selling or purchasing companies to manage the inter-company settlement conveniently without adopting credit or note transactions for the collection of sales amount or for the payment of purchase price, etc. According to the present invention, the overall settlement procedure between selling and purchasing companies is conducted entirely on-line. Thus, an embodiment of the present invention will easily minimize the inconvenience accompanying the off-line settlement method such as the complex procedure to pay purchase price and risk of theft or loss, etc., for the benefit of the selling and purchasing companies that utilize the present invention.

### TECHNICAL FIELD

The present invention relates to a system for managing inter-company settlement. In particular, the present invention relates to an inter-company settlement management system which enables seller companies and purchaser companies to conduct the sales amount collection procedure and the purchase price payment procedure more reliably by systematically implementing the overall settlement procedures conducted in between purchaser companies and seller companies on the bank on-line networks, dispensing with the inconvenience accompanying the off-line settlement procedures conducted between seller companies and purchaser companies. Furthermore, the present invention relates to a method for managing inter-company settlement using the said inter-company settlement management system.

### BACKGROUND ART

Recently, corresponding to the rapid economic development, the number of transactions between companies has increased accordingly with an outstanding speed. Corresponding to such increased transactions between companies, the inter-company settlement relations also become more and more complicated.

When the inter-company relationships are formed, seller companies which sold goods or services generally conduct certain procedures to claim the sales amount against the relevant purchaser companies. Conventionally, most purchaser companies have preferred credit transactions or payment by bills to the payment in cash because a purchaser company may manage the fund more flexibly if the payment is made by credit transactions or through bills, compared with the payment in cash.

However, the conventional credit transactions or the payments by bills involve complex processes. Thus, both purchaser companies and seller companies that use the credit transactions or payments by bills as the major payment method would have to experience a great inconvenience.

Furthermore, because the bills are generally transferred off-line, there is always a risk of theft or loss. Thus, purchaser companies and seller companies that use the bill payment method must take additional precaution measures.

If the said method of payment by bills is adopted in the relationship between a single seller company and multiple purchaser companies, the above-described disadvantages accompanying the payment by bills become more serious.

### DISCLOSURE OF INVENTION

The purpose of the present invention is to systematically implement the overall settlement procedure conducted in between seller companies and purchaser companies on the bank on-line networks and thus enable purchaser companies and seller companies to conveniently conduct the sales amount collection procedure and the purchase price payment procedure without using the credit transactions or the bill payments.

Another purpose of the present invention is to minimize the disadvantages of the off-line payment system such as the complex purchase price payment procedure of the risks of theft or loss, by conducting the overall settlement procedure between seller companies and purchaser companies on the on-line networks.

Another purpose of the present invention is to preclude purchaser companies from using the conventional payment method such as the credit transactions or the bill payments and, thus, to improve the reliability of the settlement system formed between purchaser companies and seller companies.

Another purpose of the present invention is to implement the overall collection/payment procedures conducted between seller companies and purchaser companies systematically on the on-line networks. Through such implementation of the system on the on-line networks, the overall settlement process is intended to be simplified and the competitiveness of the companies adopting the present invention is maximized.

Other purposes of the present invention will become apparent from the following detailed description and the attached drawings.

In order to attain the said purposes of the present invention, the present invention implements an inter-company settlement management system comprising a D/B block, a D/B management server and a payment management server. The said D/B block comprises an authentication information database (“D/B”) with a series of authentication information, a sales amount collection statement information D/B with the sales amount collection statement information, a credit card sales prepayment information D/B with the credit card sales prepayment information, and a registration information D/B with the registration information regarding the relevant seller companies and purchaser companies.

The D/B block stores the said authentication information, sales amount collection statement information, credit card sales prepayment information or registration information regarding the seller companies and purchaser companies, etc. selectively in the relevant field of the said D/B block, or extracts the said information from the necessary filed of the D/B block.

The said payment management server, in a state connected to the said D/B management server for telecommunication, determines whether to store or extract the said authentication information, sales amount collection statement information, credit card sales prepayment information, and registration information regarding the seller companies and purchaser companies.

Additionally, if an event for managing the sales amount collection or an event for managing the purchase price payment arises in telecommunication clients of a purchaser company and a seller company, the payment management server, in a state interfaced with the said telecommunication clients of the purchaser company and the seller company through the bank on-line networks, systematically analyzes the said authentication information, sales amount collection statement information, credit card sales prepayment information, and registration information regarding the seller companies and purchaser companies, and controls and manages the settlement relations between the relevant seller company and the purchaser company based upon the said online bank networks.

### BRIEF DESCRIPTION OF DRAWINGS

FIG. 1 is a diagram illustrating the settlement relations between companies adopting the present invention.

FIG. 2 is another diagram illustrating the settlement relations between companies adopting the present invention.

FIG. 3 is a diagram illustrating the inter-company settlement management system according to the present invention.

FIG. 4 is a flow chart illustrating the sequence of the inter-company settlement method according to a preferred embodiment of the present invention.

FIG. 5 to FIG. 7 are diagrams showing the pages displayed for the seller company's telecommunication client and the purchaser company's telecommunication client according to a preferred embodiment of the present invention.

FIG. 8 is a flow chart illustrating the sequence of the inter-company settlement method according to another preferred embodiment of the present invention.

FIG. 9 and FIG. 10 are diagrams showing the pages displayed for the purchaser company's telecommunication client according to another preferred embodiment of the present invention.

FIG. 11 is a flow chart illustrating the sequence of the inter-company settlement method according to still another preferred embodiment of the present invention.

FIG. 12 is a diagram showing the messages displayed for the seller company's telecommunication client according to still another preferred embodiment of the present invention.

FIG. 13 is a flow chart illustrating the sequence of the inter-company settlement method according to still another preferred embodiment of the present invention.

FIG. 14 and FIG. 15 are diagrams showing the pages displayed for the purchaser company's telecommunication client according to still another preferred embodiment of the present invention.

FIG. 16 is a flow chart illustrating the sequence of the inter-company settlement method according to still another preferred embodiment of the present invention.

FIG. 17a to FIG. 17d are diagrams illustrating the settlement states of the designated accounts of the purchaser company according to still another embodiment of the present invention.

### BEST MODE FOR CARRYING OUT THE INVENTION

References will now be made in detail to the preferred implementations of the present invention's inter-company settlement management system and the method therefor using the said system as illustrated in the accompanying drawings.

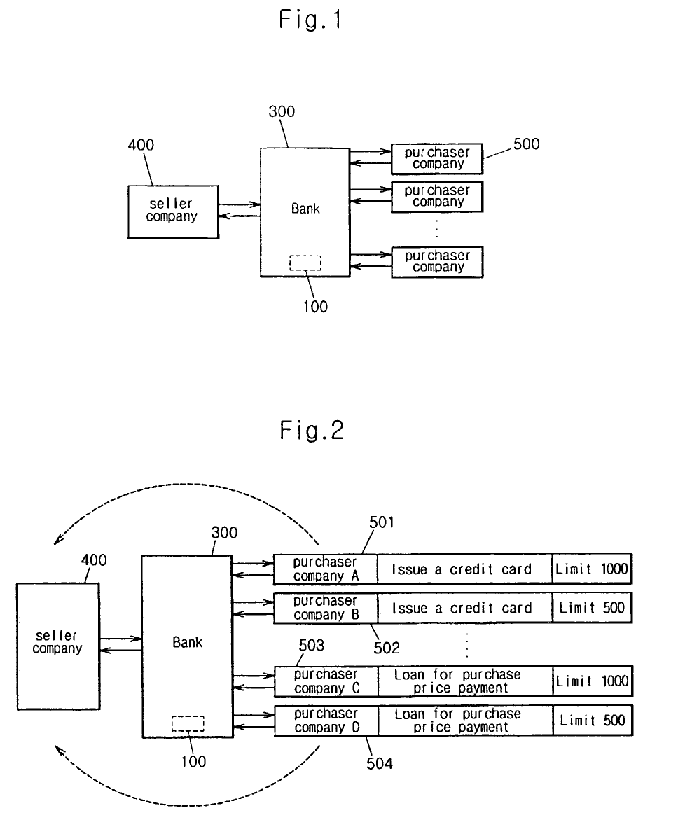

As illustrated in FIG. 1, the inter-company settlement management system (100) according to the present invention is a part of the computer on-line network of a financial institution, for example, a bank (300), which may reliably manage the settlement relations between a seller company (400) and multiple purchaser companies (500).

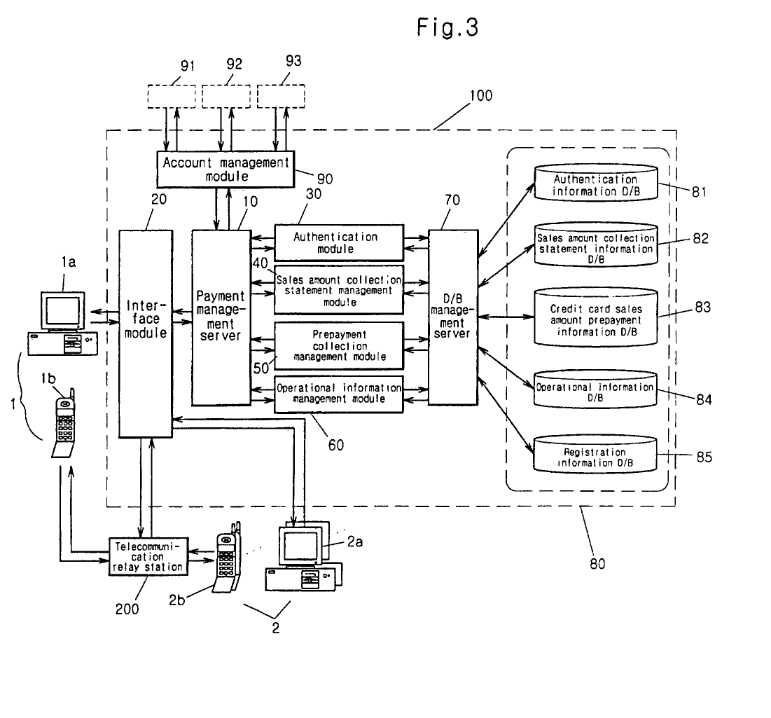

As illustrated in FIG. 2, the bank (300) adopting the present invention's inter-company settlement system (100) must have certain conditions for the effective implementation of the present invention's inter-company settlement method satisfied prior to initiating the full scale service according to the present invention. In other words, the bank (300) must have issued credit cards to purchaser companies (500) (e.g., credit cards with the maximum credit amounts of 1,000 and 500, respectively to Purchaser Company A (501) and Purchaser Company B (502)) or must have granted the loans for the purchase price payment to purchaser companies (500) (e.g., loans up to the amounts of 1,000 and 500, respectively to Purchaser Company C (503) and Purchaser Company D (504)).

Here, the bank (300) may prepare the environment in which the present invention may be legitimately implemented by executing separate agreements such as the “credit card issuance agreement” or the “loan agreement for the purchaser price payment” with the purchaser companies (500), as well as previously executing separate agreements with the seller company (400) such as the “agreement for the sales amount payment” or the “credit card membership store agreement.”

In order for the services available through the present invention to be provided to the seller company (400) without problems, the system (100) must have stored the contents of the said “agreement for the sales amount payment” or the “credit card membership store agreement.” Similarly, in order to provide the purchaser companies (500) with the present invention's services without problems, the system (100) must have stored the contents of the said “credit card issuance agreement” or the “loan agreement for the purchaser price payment.” Of course, any seller company (400) or purchaser company (500) which has not executed such agreement may not be authenticated as a registered company and thus may not enjoy the services that would otherwise be available according to the present invention.

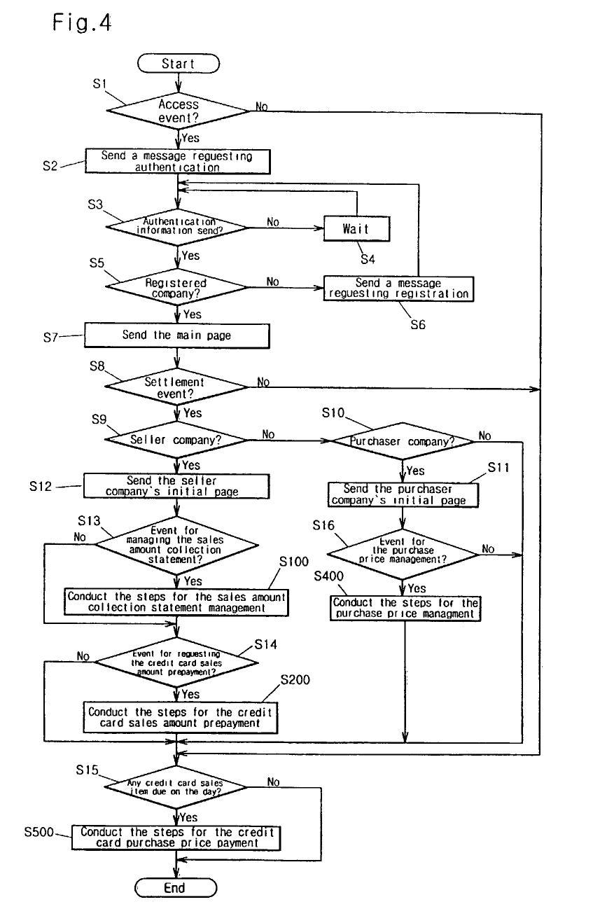

As illustrated in FIG. 3, the present invention's inter-company settlement management system (100) which belongs to the computer on-line network of the bank (300) is composed largely of the D/B block (80), D/B management server (70), and the payment management server (10). In the said D/B block (80) are located an authentication information D/B (81) with a series of authentication information, a sales amount collection statement information D/B (82) with the information on the sales amount collection statements, a credit card sales prepayment information D/B (83) with the information regarding the credit card sales prepayment, an operational information D/B (84) with a series of operational information and a registration information D/B (85) with a series of registration information regarding the seller company (400) and purchaser companies (500).

The said D/B management server (70) stores the said authentication information, sales amount collection statement information, credit card sales prepayment information, operational information or registration information selectively in the relevant field of the D/B block (80), or extracts various data from the said authentication information D/B (81), the sales amount collection statement information D/B (82), the credit card sales prepayment information D/B (83), the operational information D/B (84), or the registration information D/B (85).

Here, the said D/B management server (70) not only stores or extracts various data but also conducts an intelligent function of effectively managing the various data without redundancy within the shortest period of time possible.

As illustrated in the drawing, the said payment management server (10) is interfaced with the telecommunication client (1) of the seller company (400) and the telecommunication clients (2) of the purchaser companies (500) through a device such as an interface module (20).

More specifically, the telecommunication client (1) of the seller company (400), such as the seller company's computer (1a) and the seller company's wired/wireless telephone (1b), and the telecommunication clients (2) of the purchaser companies (500), such as the purchaser company's computer (2a) and the purchaser company's wired/wireless telephone (2b), are connected to the present invention's inter-company settlement management system (100) through the bank on-line network such as the wired/wireless Internet, automatic response system communication network, value added network, or public switched telephone network, etc.

In this state, the payment management server (10) systematically controls the D/B management server (70) through the authentication module (30), the sales amount collection statement management module (40), the prepayment collection management module (50) and the operational information management module (60). In this way, the payment management server (10) determines whether to store or extract certain authentication information, sales amount collection statement information, credit card sales prepayment information, operational information or registration information.

Additionally, if an event of managing the sales amount collection or an event of managing the purchase price payment occurs from the telecommunication client (1) of the said seller company (400) and the telecommunication client (2) of the purchaser company (500), the payment management server (10) systematically analyzes the said authentication information, sales amount collection statement information, credit card sales prepayment, operational information and registration information on the seller companies (400) and purchaser companies (500), and conducts the overall management of the settlement relations between the said seller companies (400) and the purchaser companies (500) based upon the said bank on-line networks.

The said authentication module (30) authenticates the seller company (400) or the purchaser company (500) which accesses the present invention's inter-company settlement management system (100) through the telecommunication client (1) of the seller company (400) or the telecommunication client (2) of the purchaser company (500). The authentication module (30) conducts said authentication function by checking whether the registration has been made, using the said authentication information D/B (81). The sales amount collection statement management module (40), by using the said sales amount collection statement information D/B (82), manages the sales amount collection statements that the telecommunication client (1) of the seller company (400) transmits.

Furthermore, the prepayment collection management module (50) manages the prepayment made to the seller company by the system (100), by utilizing the said credit card sales prepayment information D/B (83). The operational information management module (60), using the said operational information D/B (84) and the registration information D/B (85), manages the detailed operational matters of the payment management server (10).

Here, as illustrated in the drawing, the account management module (90) is closely connected to the payment management server (10) as the said authentication module (30), the sales amount collection statement management module (40), the prepayment collection management module (50), and operational information management module (60) are similarly connected to the payment management server (10). In the state connected for telecommunication with the payment management server (10), the account management server (90) manages the designated account (92) of the system (100), the designated account (91) of the seller company (400), and the designated account (93) of the purchaser company (500).

Now, the inter-company settlement management method using the above-described inter-company settlement management system (100) according to the present invention will be explained in detail.

First of all, the seller company (400) which sold certain goods or services and the purchaser companies (500) which purchased such goods or services access the present invention's inter-company settlement management system (100) through the said telecommunication client (1) of the seller company (400), for example, the computer (1a) of the seller company, and through the telecommunication client (2) of the purchaser company (500), for example, the computer (2a) of the purchaser company. Of course, the seller company (400) and the purchaser company (500) may also use various telecommunication clients other than the computers (1a or 2a). For instance, the wired/wireless communication device (1b) on the seller company or the wired/wireless communication device (2b) on the purchaser company may be selected for access to the inter-company settlement management system (100).

If the seller company (400) or the purchaser company (500) selects the wired/wireless communication device (1b or 2b) for the access to the present invention's system, the telecommunication relay station (200) transmits data from the seller company's wired/wireless communication device (1b) or the purchaser company's wired/wireless communication device (2b) to the interface module (20), and vice versa.

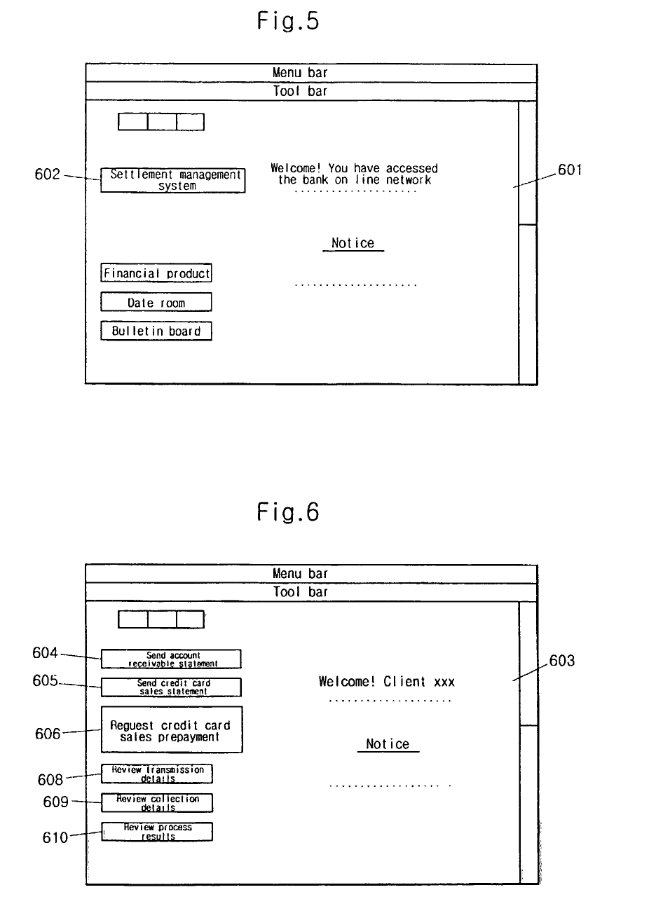

When the said environment is in place, as illustrated in FIG. 4, the payment management server (10) determines whether there is a system access event from the seller company's computer (1a) or the purchaser company's computer (2a) (Step S1).

If there has been no system access event from the seller company's computer (1a) or the purchaser company's computer (2a), the payment management server (10) proceeds to conduct Step S15 as described below.

However, if there is a system access event from either the seller company's computer (1a) or the purchaser company's computer (2a), the payment management server (10) extracts the relevant operational information from the operational information D/B (80) by using the operational information management module (60). Thereafter, using such operational information, the payment management server (10) generates an authentication request message and transmits the generated authentication request message to the relevant computer that has issued the system access event (Step S2).

If the system access event has arisen from the seller company's computer (1a), such authentication request message will be transmitted to the seller company's computer (1a). In contrast, if the purchaser company's computer (2a) has issued the system access event, the authentication request message will be transmitted to the purchaser company's computer (2a).

Then, the relevant computer, for example, the seller company's computer (1a) or the purchaser company's computer (2a), interprets the authentication request message transmitted from the payment management server (10) and displays such message so that the relevant seller company (400) or the purchaser company (500) may obtain the authentication expeditiously.

The payment management server (10) continuously checks with the interface module (20) to determine whether the seller company's computer (1a) or the purchaser company's computer (2a) has transmitted the requested authentication information (Step S3).

If it is determined that the seller company's computer (1a) or the purchaser company's computer (2a) has not transmitted authentication information, the payment management server (10) considers that the relevant computer has not yet completed the input of the authentication information and goes to Step S4 to wait for the authentication information.

In contrast, if it is determined that the seller company's computer (1a) or the purchaser company's computer (2a) has transmitted authentication information, the payment management server (10) immediately contacts the authentication module (30) to determine whether the seller company (400) or the purchaser company (500) which is presently connected to the system (100) through the relevant seller company's computer (1a) or the purchaser company's computer (2a) has been registered with the system (Step S5).

If it is determined that the management company accessing the system (100) is not a registered management company, the payment management server (10) generates a registration request message and transmits such registration request message to the computer of the relevant company (Step S6). Such message may state, for example, “You are not a registered client. Please register first.”

In contrast, if the management company accessing the system (100) is determined to be a registered management company, the payment management server (10) generates a main page and transmits such main page to the computer of the relevant management company such as the seller company's computer (1a) or the purchaser company's computer (2a) (Step S7).

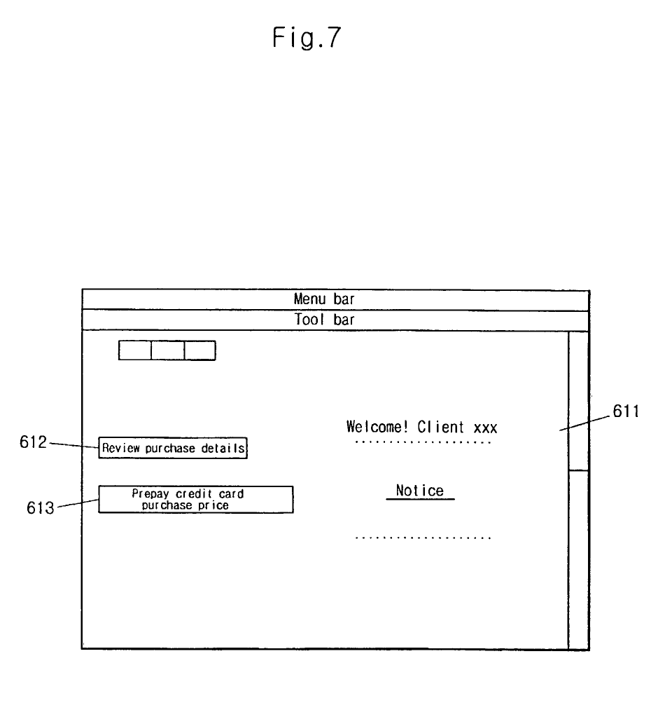

Then, the relevant computer of the management company expeditiously interprets the main page (601) transmitted from the system (100) and displays it as illustrated in FIG. 5. Thus, the basic environment in which the seller company (400) and the purchaser companies (500) may conveniently conduct the inter-company settlement processes is established.

On the other hand, in the state where the main page (601) is displayed in the relevant management company's computer (the seller company's computer (1a) or the purchaser company's computer (2a)), the payment management server (10) determines whether there has been a settlement event from the relevant management company's computer (Step S8).

If it is determined that there has been no settlement event from the relevant management company's computer, the payment management server (10) proceeds to conduct Step S15 as described below.

However, if either the seller company (400) or a purchaser company (500) clicks, for example, the “settlement management system (602)” on the main page (601) and thus it is determined that there has been a settlement event from the seller company's computer (1a) or the purchaser company's computer (2a), the payment management server (10), using the operational information management module (60), collects the relevant registration information regarding the relevant management company from the registration information D/B (86) and then determines whether the connected management company is a seller company (400) or a purchaser company (500) (Steps S9 and S10).

If the company is determined to be a seller company (400), the payment management server (10) generates an initial page for a seller company reflecting the relevant seller company's registration information. When such initial page is completed, the payment management server (10) transmits the initial page to the seller company's computer (1a) (Step S12).

The seller company's computer (1a) then immediately interprets the transmitted initial page for a seller company (603) and displays the page as illustrated in FIG. 6, enabling the seller company to conveniently conduct the sales amount collection process.

Here, as illustrated in the drawing, the initial page for a seller company (603) contains, for example, “transmit account receivable statement (604),” “transmit credit card sales statement (605),” “credit card sales prepayment request (606),” “review the transmitted details (608),” “review collection details (609)” and “review the process result (610),” etc. The seller company (400), by selecting and clicking the relevant item, may confirm or set the relevant item real time. Of course, these items may be changed according to the relevant circumstances.

For instance, after the transmission of the credit card sales statement as described below, the seller company (400) that wishes to operate the fund through the credit card sales prepayment process may select the item “credit card sales prepayment request (606)” from the initial page for a seller company (603). In this manner, the credit card sales prepayment request information may be created.

The credit card sales prepayment request information means the information regarding the request of prepayment of the credit card sales amount made by the seller company (400), which sold the goods or services, to the bank (300) associated with the purchaser company (500), which paid the purchase price for the goods or services using the company's credit card. The financial institution such as the bank (300), based upon the “credit card sales prepayment information,” prepays the “credit card payment amount” on behalf of the purchaser company (500) to the seller company (400). Consequently, the seller company (400) may collect the sales amount for the goods or services it has provided.

In the state where the initial page for a seller company (1a) is displayed on the seller company's computer (1a) as described above, the payment management server (10) determines whether there has been an event for the sales amount collection statement management from the seller company's computer (1a) (Step S13).

The sales amount collection statement means a statement containing detailed sales information such as “sold goods, sales price, payment means, payment date, etc.” If the seller company (400) transmits a “credit card sales statement” as the said sales amount collection statement, this means that the purchaser company (500)'s payment means is the company's credit card. If the seller company (400) transmits an “account receivable statement” as such sales amount collection statement, this means that the purchaser company (500) is using the account receivable as the payment means.

Here, the company's credit card means a special credit card that the bank (300) adopting the present invention's inter-company settlement system (100) issues to the purchaser company (500) which has entered into the said “credit card issuance agreement.”

Here, if it is determined that there has been no event for the sales amount collection statement management from the seller company's computer (1a), the payment management server proceeds to conduct Step S14 as described below.

However, if the seller company (400) clicks, for example, “transmit account receivable statement (604)” or “transmit credit card sales statement (605)” on the initial page for a seller company (603) and thus it is determined that there has been an event for the sales amount collection statement management from the seller company's computer (1a), the payment management server (10) refers to the sales amount collection statement information transmitted from the said seller company's computer (1a) and conducts expeditiously the process for managing the sales amount collection statement (Step S100).

When the process for managing the sales amount collection statement is completed through the said Step S100, the payment management server (10) determines whether there has been an event for requesting the credit card sales prepayment from the seller company's computer (1a) (Step S14).

If it is determined that there has been no event for requesting the credit card sales prepayment from the seller company's computer (1a), the payment management server (10) proceeds to conduct Step S15 as described below.

In contrast, if the seller company (400) clicks, for example, the item “credit card sales prepayment request (606)” on the initial page for a seller company (603) and thus if it is determined that there has been an event for requesting the credit card sales prepayment from the seller company's computer (1a), the payment management server (10) refers to the credit card sales prepayment request information transmitted from the said seller company's computer (1a) and conducts expeditiously the step for the credit card sales prepayment (Step S200).

On the other hand, in the said Step S10, if the management company is determined to be a purchaser company (500) instead of a seller company (400), the payment management server (10) generates an initial page for a purchaser company reflecting the relevant purchaser company's registration information. When such initial page is completed, the payment management server (10) transmits the initial page to the purchaser company's computer (2a) (Step S11).

The purchaser company's computer (2a) immediately interprets the said initial page designed for a purchaser company (611) and displays the page as illustrated in FIG. 7. Thus, the purchaser company (500) may conveniently conduct the steps for the purchase price management.

As illustrated in the drawing, the initial page for a purchaser company (611) contains, for example, “review the purchase details (612),” “credit card purchase amount prepayment (613),” etc. The purchaser company (500), by selecting and clicking the items described above, may confirm or set the relevant item real time. Of course, as with the initial page designed for a seller company (603), the above-mentioned items may be modified according to the relevant circumstances.

Here, the purchaser company (500), by selecting the item “credit card purchase amount prepayment (613)” on the initial page (611), may generate the credit card purchase amount prepayment information. The said credit card purchase amount prepayment information means the information on certain credit card purchase amount paid prior to the due date by the purchaser company (500), which purchased certain goods or services from the seller company (400). The present invention's system (100), based upon the said “credit card purchase amount prepayment information,” transfers the “credit card payment amount” from the specific account designated by the purchaser company (500). In this manner, depending on the purchaser company (500)'s intention, certain credit card payment amount may be prepaid even before the due date.

Through the steps described above, in the state where the purchaser company's initial page (611) is displayed on the purchaser company's computer (2a), the payment management server (10) determines whether there has been an event for the purchase price management from the purchaser company's computer (2a) (Step S16).

Here, if it is determined that there has been no purchase price management event from the purchaser company's computer (2a), the payment management server proceeds to conduct Step S17 as described below.

In contrast, if the purchaser company (500) clicks “review the purchase details (612)” or “credit card purchase amount prepayment (613)” and thus if it is determined that there has been an event for the purchase price management from the purchaser company's computer (2a), the payment management server (10) refers to the purchase price management information that the purchaser company's computer (2a) transmitted and conducts expeditiously the steps for the purchase price management (Step S300).

Now, the said step for the sales amount collection statement management (Step S100), the step for the credit card sales prepayment (Step S200) and the step for the purchase price management (Step S300) will be explained in detail.

First, the said step for the sales amount collection statement management (Step S100) will be explained below in detail.

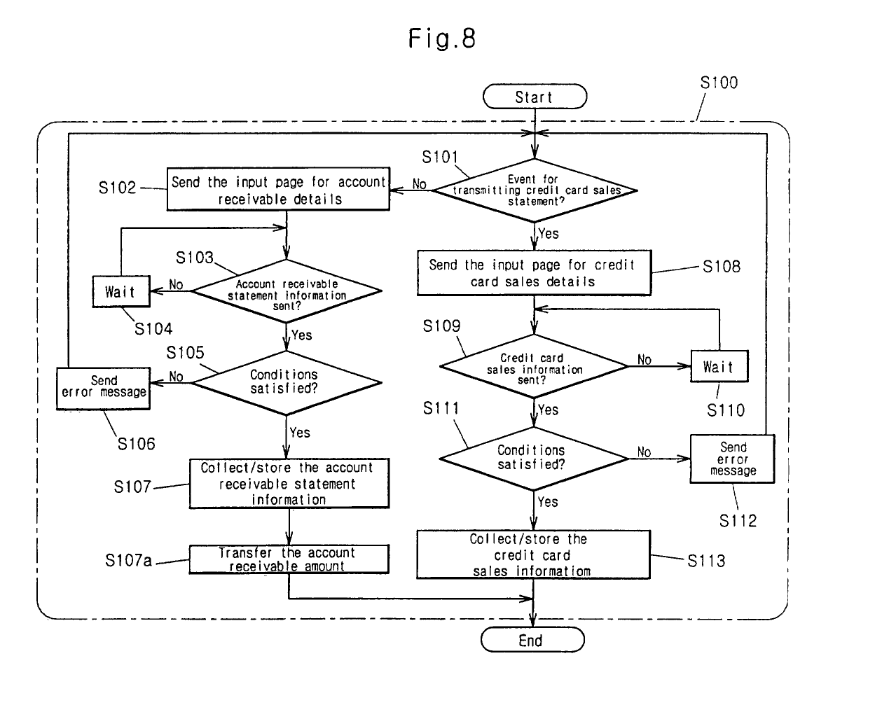

As illustrated in FIG. 8, the payment management server (10) determines whether there has been any event for sending the credit card sales statement from the seller company's computer (1a) by continuously checking with the interface module (20) (Step S101).

At this time, if the seller company (400) clicks the item “send the account receivable statement (604)” on the initial page (601) and accordingly if it is determined that an event for sending the account receivable statement has occurred instead of an event for sending the credit card sales statement, the payment management server (10) uses the operational information management module (60) to generate the message for inputting the details regarding the account receivable. When the page is completed, the payment management server sends the completed page for inputting the details regarding the account receivable to the seller company's computer (1a) through the interface module (20) (Step S102).

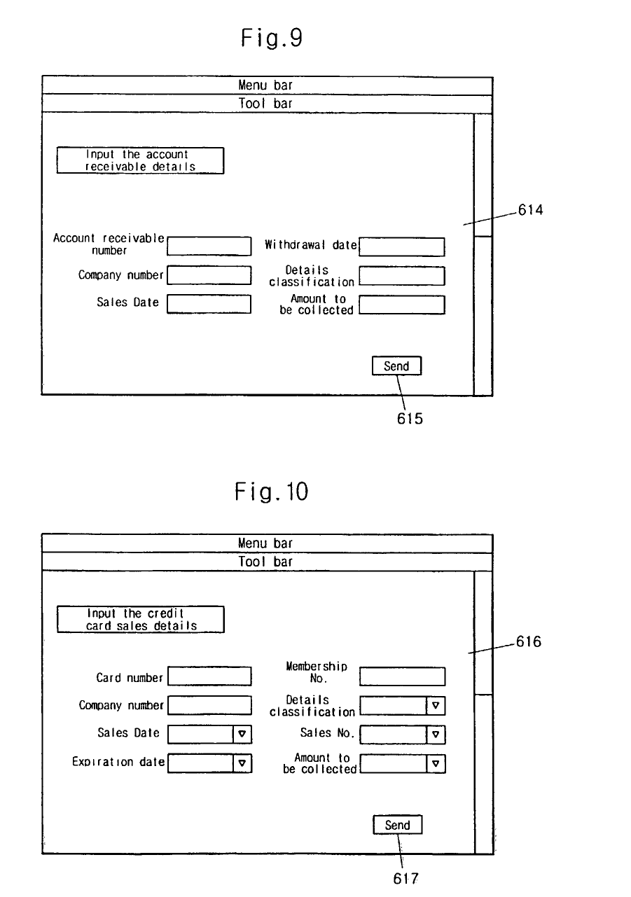

The seller company's computer (1a) then quickly interprets the message for inputting the details regarding the account receivable (614) and displays it as illustrated in FIG. 9, providing the stable environment in which the seller company (400) may create the information regarding the account receivable.

At this stage, the payment management server (10) continually checks with the interface module (20) and determines whether the seller company's computer (1a) has transmitted the information on the account receivable statement (Step S103).

If the seller company (400) has not yet inputted the details regarding the account receivable statement and thus if the information on the account receivable statement has not yet been transmitted from the seller company's computer (1a), the payment management server (10) moves to Step S104 and maintains the waiting state.

In contrast, if the seller company (400) completed the input of the details regarding the account receivable statement and clicked the item “send” (617) and, thus, if it is determined that the seller company's computer (1a) has transmitted the information on the account receivable statement, the payment management server (10) determines whether the said information on the account receivable statement is acceptable. For instance, it is determined whether the amount recorded in the said information as the account receivable amount to be collected is within the limit of the loan limit amount of the relevant purchaser company (500), whether the designated account of the purchaser company (93) has certain balance amount that may be withdrawn and whether the purchaser company (500) recorded in the said information as the company to pay is a registered purchaser company, etc. (Step S105).

Here, if the amount recorded in the said information exceeds the limit of the loan amount, if there is no sufficient balance that may be withdrawn in the purchaser company's designated account (93), or if the purchaser company (500) recorded as the company to pay is not a registered purchaser company (500); the payment management server (10) proceeds to conduct a step to send an error message to the seller company's computer (1a) (Step S106).

In such an event, the payment management server (10) uses the operational information management module (60) to extract certain operational information which has been stored in the operational information D/B (84). Then, the payment management server (10), using such operational information, generates an error message such as “The amount inputted exceeds the limit amount of the purchaser company. Please try again.” The generated error message is transmitted to the seller company's computer (1a).

In contrast, if the amount recorded in the information on the account receivable statement does not exceed the pre-designated loan limit amount of the relevant purchaser company (500), if there is sufficient balance in the purchaser company's designated account (93) that may be withdrawn, and if the purchaser company (500) recorded as the company to be paid is determined to be a registered purchaser company (500), the said information on the account receivable statement is deemed acceptable. Accordingly, the payment management server (10) proceeds to collect and store the said information on the account receivable statement and to conduct the step to transfer the recorded amount of the account receivable to be collected from the purchaser company's designated account (93) to the seller company's designated account (Steps S107 and S107a).

First, the payment management server (10) transmits the information on the account receivable statement, which has been transmitted from the seller company's computer (1a), to the sales amount collection statement management module (40). The sales amount collection statement management module (40), immediately upon receiving the information on the account receivable statement, transmits the said information to the D/B management server (70). In this manner, the information on the account receivable statement is collected and stored in the sales amount collection statement information D/B (82).

Thereafter, the payment management server (10) controls the account management server (90) to transfer the “loan amount for the purchase price payment” deposited in the purchaser company's designated account (93) to the seller company's designated account (91). In this manner, the seller company (400) may collect the entire sales amount for the goods or services that it has provided.

On the other hand, in the said Step S101, if the seller company (400) clicks the item “send the credit card sales statement” (605) on the initial page (603) and if it is accordingly determined that an event for sending the credit card sales statement has occurred, the payment management server (10) uses the operational information management module (60) to generate the message for inputting the details of the credit card sales statement. The payment management server (10) then transmits the completed message for inputting the details of credit card sales statement to the seller company's computer (1a) through the interface module (20) (Step S108).

In this event, the seller company's computer (1a) quickly interprets the message for inputting the details of the credit card sales statement (616), which has been sent by the payment management server (10), and then displays the message as illustrated in FIG. 10, providing the stable environment in which the seller company (400) may create the information on the credit card sales statement.

At this stage, the payment management server (10) continually checks with the interface module (20) and determines whether the seller company's computer (1a) has transmitted the information on the credit card sales statement (Step S109).

If the seller company (400) has not yet inputted the details regarding the credit card sales statement and thus if it is determined that the information on the credit card sales statement has not yet been transmitted from the seller company's computer (1a), the payment management server (10) moves to Step S110 and maintains the waiting state.

In contrast, if the seller company (400) completed the input of the details regarding the credit card sales statement and clicked the item “send” (617) and, thus, it is determined that the seller company's computer (1a) has transmitted the information on the credit card sales statement, the payment management server (10) determines whether the said information on the credit card sales statement is acceptable. For instance, it is determined whether the credit card amount recorded in the said information as the amount to be collected is within the pre-determined limit of the seller company and within the debt limit amount of the relevant purchaser company and whether the purchaser company (500) recorded in the said information as the company to pay is a registered purchaser company (500). (Step S11).

Here, if the amount recorded in the said information as the credit card amount to be collected exceeds the limit amount of the seller company or the debt limit amount of the relevant purchaser company or if the purchaser company (500) recorded as the company to be pay is not a registered purchaser company (500), the payment management server (10) proceeds to conduct a step to send an error message to seller company's computer (1a) (Step S112).

In such an event, the payment management server (10) uses the operational information management module (60) to extract certain operational information which has been stored in the operational information D/B (85). Then, the payment management server (10), using such operational information, generates an error message such as “The amount inputted exceeds the limit amount. Please try again.” The generated error message is transmitted to the seller company's computer (1a).

In contrast, if the amount recorded in the information on the credit card sales statement does not exceed the limit amount of the seller company and the debt limit amount of the relevant purchaser company and if the purchaser company (500) recorded as the company to pay is determined to be a registered purchaser company (500), the said information on the credit card sales statement is deemed acceptable. Accordingly, the payment management server (10) proceeds to collect and store the said information on the credit card sale statement (Step S113).

The payment management server (10) transmits the information on the credit card sales statement, which has been transmitted from the seller company's computer (1a), to the sales amount collection statement management module (40). The sales amount collection statement management module (40), immediately upon receiving the information on the credit card sales statement, transmits the said information to the D/B management server (70). In this manner, the information on the credit card sales statement is collected and stored in the sales amount collection statement information D/B (82).

Now, the said step of the credit card sales amount prepayment (Step S200) will be explained in detail.

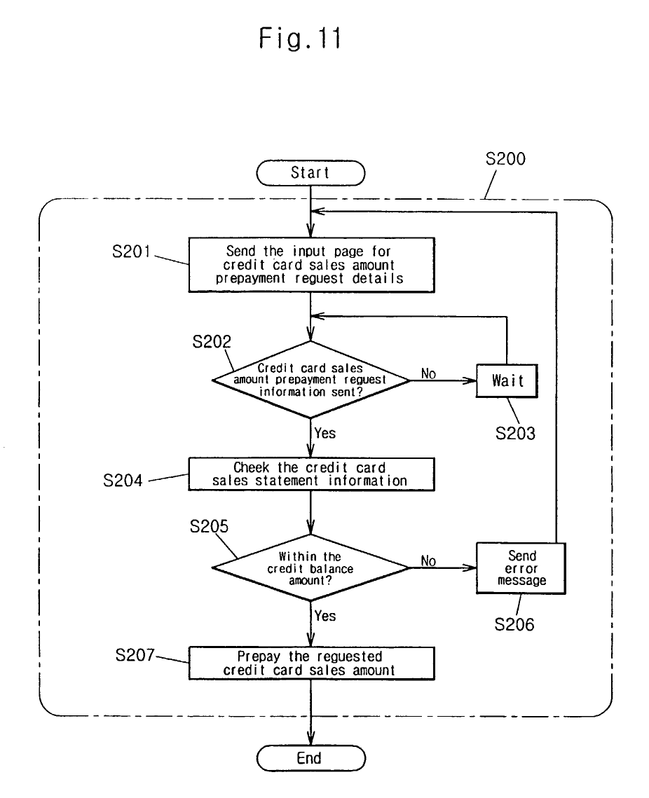

First, if it is determined through the said step S14 that an event for requesting the credit card sales amount prepayment has occurred in the seller company (400), as illustrated in FIG. 11, the payment management server (10) generates the page for inputting details regarding the credit card sales amount prepayment request using the operational information management module (60) and transmits the completed input page to the seller company's computer (1a) (Step S201).

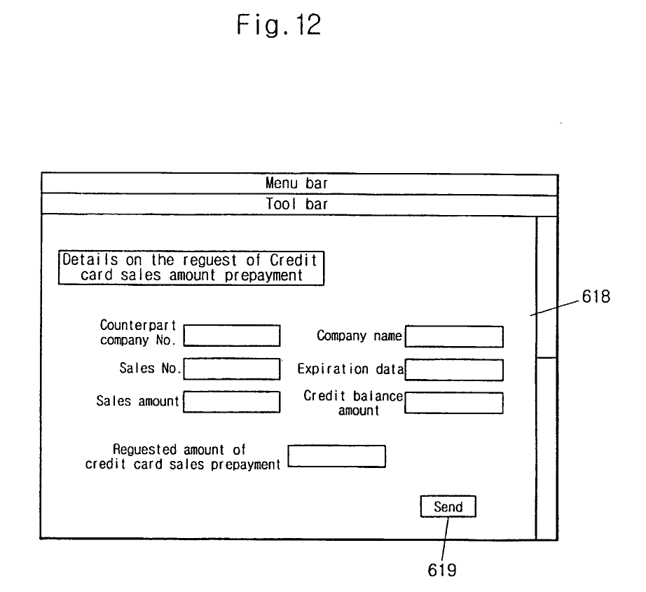

In this event, the seller company's computer (1a) quickly interprets the message for inputting the details of the credit card sales amount prepayment request (618), which has been sent by the payment management server (10), and then displays the message as illustrated in FIG. 12, providing the stable environment in which the seller company (400) may expeditiously conduct the step for the credit card sales amount prepayment request.

At this stage, the payment management server (10) continually checks with the interface module (20) and determines whether the seller company's computer (1a) has transmitted the information on the credit card sales amount prepayment request (Step S202).

If the seller company (400) has not yet inputted the details regarding the credit card sales amount prepayment request and thus if it is determined that the information on the credit card sales amount prepayment request has not yet been transmitted from the seller company's computer (1a), the payment management server (10) moves to Step S203 and maintains the waiting state.

In contrast, if the seller company (400) completed the input of the details regarding the credit card sales amount prepayment request and clicked the item “send” (619) and, thus, it is determined that the seller company's computer (1a) has transmitted the information on the credit card sales amount prepayment request, the payment management server (10) determines whether the said information on the credit card sales statement is acceptable using the sales amount collection statement management module. For instance, by checking the credit card sales statement stored in the sales amount collection statement information D/B (82), it is determined whether the credit card amount recorded in the said information as the amount to be prepaid is within the predetermined limit of the credit balance amount. (Steps S204 and S205).

Here, if the amount recorded in the said information as the credit card amount to be prepaid exceeds the amount of the credit balance limit, the payment management server (10) proceeds to conduct a step to send an error message to seller company's computer (1a) (Step S206).

In such an event, the payment management server (10) uses the operational information management module (60) to extract certain operational information which has been stored in the operational information D/B (84). Then, the payment management server (10), using such operational information, generates an error message such as “The amount inputted exceeds the credit limit amount. Please try again.” The generated error message is transmitted to the seller company's computer (1a).

In contrast, if the amount recorded in the information on the credit card sales amount prepayment request information does not exceed the credit balance limit amount, the payment management server (10) proceeds to prepay the “requested credit card prepayment amount” to the seller company (400) on behalf of the purchaser company (500) (Step S207).

The payment management server (10) instructs the account management module (90) to prepay the “requested credit card prepayment amount.” The account management module (90), immediately upon receiving the said instruction, transfers the relevant amount of cash from the system's designated account (92) to the seller company's designated account (93). Consequently, the seller company (400) which provided certain goods or services to the purchaser company (500) may conveniently receive the “requested prepayment amount of the credit card sales” on line.

Now, the said step of the purchase price management (Step S300) will be explained in detail.

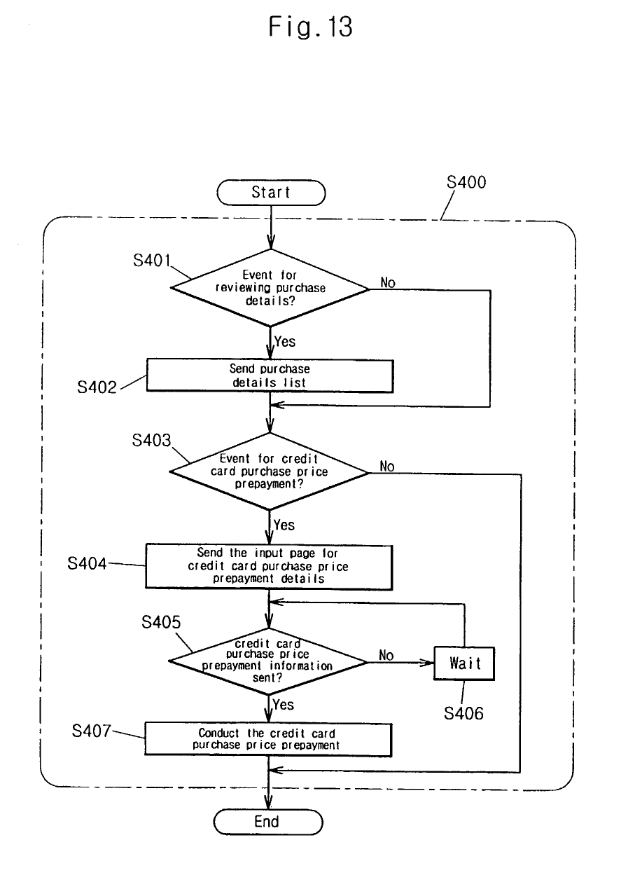

First, as illustrated in FIG. 13, the payment management server (10), by continuously checking with the interface module (20), determines whether there has been any event for reviewing the purchase details from the purchaser company's computer (2a) (Step S401).

If it is determined that no event for reviewing the purchase details has occurred, the payment management server (10) proceeds to conduct Step S403 as described below.

In contrast, if the purchaser company clicks the item “review the purchase details (612)” in the purchaser company's initial page (611) and accordingly if it is determined that there has been an event for reviewing the purchase details from the purchaser company's computer (2a), the payment management server (10) generates a list for the purchase details using the operational information management module (60) and transmits the completed list of the purchase details to the purchaser company's computer (2a) through the interface module (20) (Step S402).

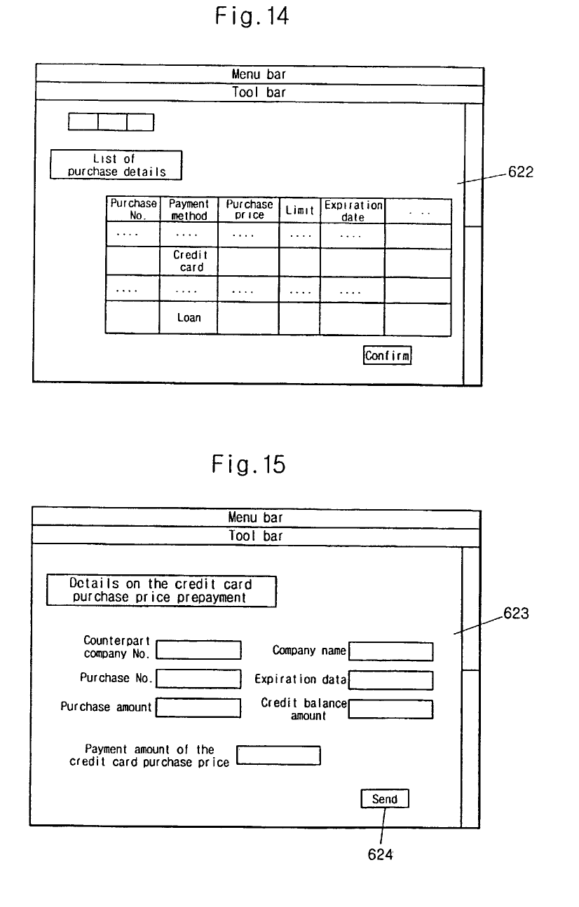

In this event, the purchaser company's computer (2a) quickly interprets the list of the purchase details (622), which has been sent by the payment management server (10), and then displays the message as illustrated in FIG. 14, providing the stable environment in which the purchaser company (500) may conveniently review the purchase details such as the purchased goods, payment date, payment amount, etc.

Then, the payment management server (10) continually checks with the interface module (20) and determines whether there has been any event for the credit card purchase price prepayment from the purchaser company's computer (2a) (Step S403).

If there has been no event for the credit card purchase price prepayment from the purchaser company's computer (2a), the payment management server (10) terminates the process flow.

In contrast, if the purchaser company (500) clicks the item “credit card purchase price prepayment (613)” and thus if it is determined that there has been an event for the credit card purchase price prepayment from the purchaser company's computer (2a), the payment management server (10) generates the page for inputting details of the credit card purchase price prepayment using the operational information management module. Then the payment management server (10) transmits the completed page for inputting the details of the credit card purchase price prepayment to the purchaser company's computer (2a) through the interface module (Step S404).

The purchaser company's computer (2a) then quickly interprets the page for inputting the details of the credit card purchase price prepayment (623), which has been transmitted from the payment management server (10) and displays it as illustrated in FIG. 15, providing a stable environment in which the purchaser company (500) may prepay certain amount of the credit card purchase price.

In this state, the payment management server (10) continuously checks with the interface module (20) to determine whether the purchaser company's computer (2a) has transmitted the credit card purchase price prepayment information (Step S405).

If the purchaser company (500) has not yet completed the step for inputting the details of the credit card purchase price prepayment and thus it is determined that the purchaser company's computer (2a) has not transmitted the credit card purchase price prepayment information, the payment management server (10) moves to Step S406 and maintains the waiting state.

In contrast, if the purchaser company (500) completed the step for inputting the details of the credit card purchase price prepayment and clicked the item “send (624),” it is determine that the purchaser company's computer (2a) has transmitted the credit card purchase price information. Then, the payment management server (10) immediately proceeds to conduct the step for the credit card, purchase price prepayment based upon the said credit card purchase price prepayment information (Step S407).

At this stage, the payment management server (10) instructs the account management module (90) to prepay the “credit card purchase price.” The account management module (90), immediately upon receiving the said instruction, transfers the relevant amount of cash from the account designated by the purchaser company (500) to the seller company's designated account (91). Consequently, the purchaser company (500), which has purchased certain goods or services, may conveniently prepay certain amount of credit card purchase price prior to the due date for the payment.

On the other hand, as illustrated in the said FIG. 4, when the step for the credit card sales amount prepayment (Step S200) is completed, the payment management server (10), by utilizing the sales amount collection statement management module (40), extracts the sales amount collection statement information (such as the credit card sales statement information) from the sales amount collection statement information D/B (82). Then, the payment management server (10) checks the said credit card sales statement information to determine whether the credit card sales statement contains any credit card sales item which is due on the present day (Step S15).

If there is no credit card sales item which is due on the present day, in the credit card sales statement stored in the sales amount collection statement information D/B (82), the payment management server (10) terminates the process flow.

In contrast, if the credit card sales statement stored in the sales amount collection statement information D/B (82) contains an credit card sales item which is due on the present day, the payment management server (10) checks the purchaser company's designated account (93) and quickly proceeds to conduct the step for the credit card purchase price settlement related to the credit card sales item which is due on the present day (Step S500).

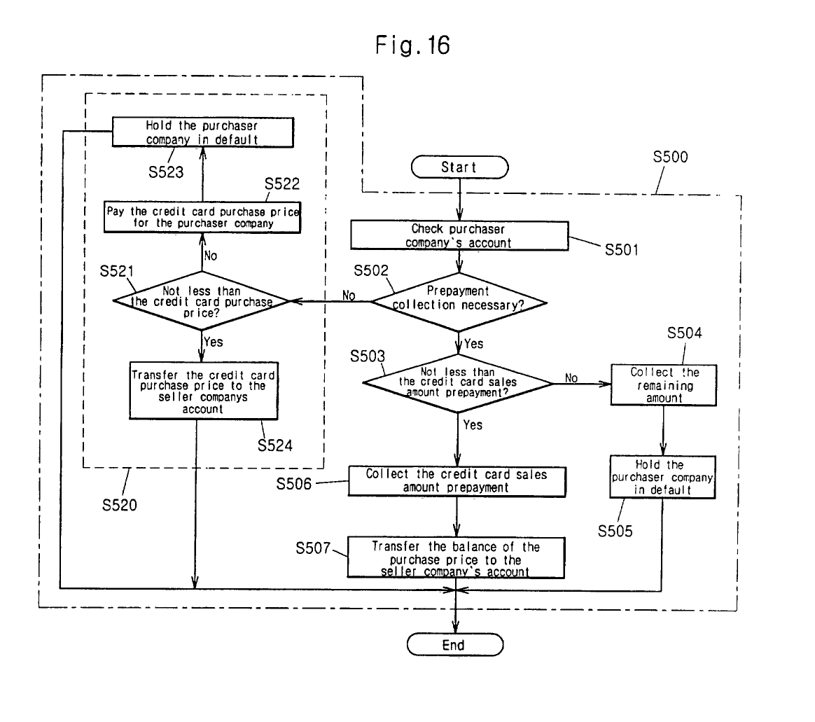

First, as illustrated in FIG. 16, the payment management server (10) controls the account management server (90) to closely review the designated account (91) of the purchaser company (500), which is related to the credit card sales item that is due on the present day (Step S501).

Thereafter, the payment management server determines whether the credit card sales item due on the present day is subject to the “prepayment amount collection process” in which the prepayment conducted through the said Step S207 is collected (Step S502).

If the seller company (400) related to the credit card sales item due on the present day is an ordinary seller company (400) which has not been subjected to the above-described “step for the credit card sales amount prepayment,” the credit card sales item due on the present day is determined not to be the item subject to the “prepayment amount collection process.” Then, the payment management server (10) expeditiously conducts the “process for the ordinary items” (Step S520).

First, the payment management server (10) determines whether the amount deposited in the purchaser company's designated account (93) is not less than the “credit card purchase price of the purchaser company (500)” (Step S521).

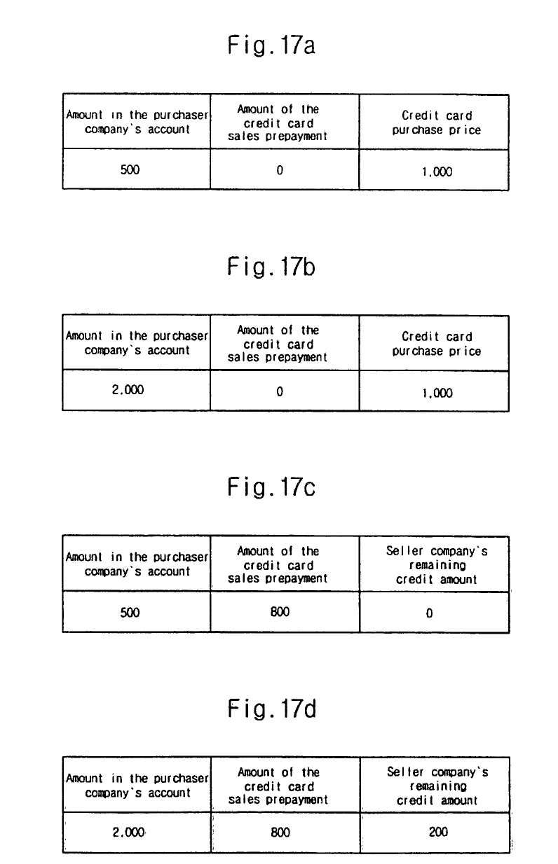

As illustrated in FIG. 17a, if the credit card purchase price of the purchaser company (500) is 1000 and the amount deposited in the purchaser company's designated account (93) is 500, and thus it is determined that the amount deposited in the purchaser company's designated account (93) is less than the credit card purchase price of the purchaser company (500), then the payment management server (10), on behalf of the purchaser company (500), pays to the seller company (400) the purchaser company's credit card purchase price, 1000, to be collected by the seller company (400) (Step S522).

When the said payment is completed, the payment management server (10) collects 500, the amount which has been deposited in the purchaser company's designated account (93), and holds the relevant purchaser company (500), which is a credit card debtor to the bank (300), in default for the difference of the amounts, 500 (Step S523).

In this event, the payment management server (10) transmits to the operational module (60) the message reading “Hold the purchaser company (500) in default.” The operational module (60), immediately upon receiving the said message, modifies the registration information regarding the relevant purchaser company (500) stored in the registration information D/B (85). Thus, the relevant purchaser company (400) is classified and managed as a company in default.

In contrast, as illustrated in FIG. 17b, if the credit card purchase price of the purchaser company is 1000 and the amount deposited in the purchaser company's designated account (93) is 2000, the amount deposited in the purchaser company's designated account (93) is greater than the credit card purchase price of the purchaser company (500). Then, the payment management server proceeds to conduct the step for collecting the purchaser company (500)'s credit card purchase amount in the ordinary manner (Step S524).

The payment management server (10) instructs the account management module (90) to collect the relevant amount from the purchaser company's designated account (93). The account management module (90), immediately upon receiving the said instruction, transfers 1000 out of 2000, which is deposited in the purchaser company's designated account (93), to the seller company's designated account (91). Consequently, the seller company (400) may collect the sales amount for the goods or services that it has provided.

On the other hand, in the said step S502, if the seller company (400) related to the credit card sales item due on the present day is the seller company (400) which received that “credit card sales amount prepayment” as described above, and thus if it is determined that the credit card sales item due on the present day is subject to the “prepayment collection process,” the payment management server (10) extracts the credit card sales amount prepayment information using the prepayment collection management module (50). Thereafter, the payment management server (10) determines whether the amount deposited in the purchaser company's designated account (93) is not less than the “the credit card sales prepayment amount” (Step S503).

As illustrated in FIG. 17c, if the credit card sales prepayment amount is 800 and the amount deposited in the purchaser company's designated account (93) is 500, it is determined that the amount deposited in the purchaser company's designated account (93) is less than the credit card sales prepayment amount. Then, the payment management server (10) collects 500, the amount deposited in the purchaser company's designated account (93) and proceeds to conduct the step to hold the purchaser company (500), which is a credit card debtor to the bank (300), in default for the difference in the amounts, 300 (Steps S504 and S505).

Here, the payment management server (10) transmits the message reading “Hold the purchaser company (500) in default” to the operational module (60). The operational module (60), immediately upon receiving the said message, modifies the registration information of the relevant purchaser company (500). Thus, the purchaser company is classified and managed as a company in default.

In contrast, as illustrated in FIG. 17d, if the credit card sales prepayment amount is 800 and the amount deposited in the purchaser company's designated account (93) is 2000, it is determined that the amount deposited in the purchaser company's designated account (93) is greater than the credit card sales prepayment amount. Then, the payment management server (10) proceeds to conduct the step to ordinarily collect the prepaid “credit card sales prepayment amount” (Step S506).

In this event, the payment management server (10) instructs the account management module (90) to collect the relevant amount from the purchaser company's designated account (93). The account management module (90), immediately upon receiving the said instruction, transfers the relevant amount 800 out of 2000, which is the available fund of the purchaser company (500), from the purchaser company's designated account (93) to the system's designated account (92). In this manner, the bank (300) may conveniently collect the prepaid amount which it has paid in the above-described “step for the credit card sales prepayment.”

Once the collection of the “credit card sales prepayment amount” is completed through the above-described steps, the payment management server (10) proceeds to conduct the step to transfer, from the purchaser company (500)'s fund to the seller company's designated account (91), the balance of the sales amount to be paid to the seller company after subtracting the said “credit card sales prepayment amount” (Step S507).

In such an event, the payment management server (10) instructs the account management module (90) to transfer the said relevant balance amount from the purchaser company's designated account (93). Immediately upon the occurring of the said instruction event, the account management module (90) transfers the “balance of the seller company (400)'s credit amount,” 200 in this case, from the purchaser company (500)'s designated account (93) with the remaining fund 1200, to the seller company's designated account (91). Consequently, the seller company (400) may receive the entire sales amount for the goods or services it has provided.

Thereafter, whenever an event for the sales amount management or the purchase price management arises from the seller company's telecommunication client (1) or the purchaser company's telecommunication client (2), the payment management server (10) coordinates the said authentication module (30), the sales amount collection statement management module (40), the prepayment collection management module (50), the operational information management module (60) and the account management module (90) so that the steps for the sales amount collection management or the steps for the purchase price payment management may be systematically conducted. Resultantly, the seller company (400) and the purchaser companies (500) may establish a reliable settlement relationship based upon the bank on-line network.

As explained above in detail, the present invention, by implementing, on the bank on-line network, the overall settlement procedure conducted between seller companies and purchaser companies, enables the relevant seller companies and purchaser companies to conduct the sales amount collection procedure and the purchase price payment procedure conveniently without adopting credit or note transactions for such procedures.

According to the present invention, the overall settlement procedures between seller companies and purchaser companies are conducted entirely on-line. Thus, an embodiment of the present invention will easily minimize, for the seller companies and purchaser companies that utilize the present invention, the inconvenience accompanying the off-line settlement method such as the complex procedure to pay purchase price and risk of theft or loss, etc.

Furthermore, upon the fulfillment of the present invention, purchaser companies would be prevented from using the conventional credit or note transaction methods. Therefore, an embodiment of the present invention will enhance the trustworthiness of the settlement relationship formed between the relevant seller companies and purchaser companies.

Preferred embodiments of the present invention have been specifically explained and illustrated in the above. However, it is apparent to persons skilled in the relevant art that the present invention may be modified in various manners and implemented accordingly.

Such modified implements must not be understood separately from the present invention in terms of the technology involved and must be deemed included in the extent of claims of the present invention attached hereto.

What is claimed is:

1. An inter-company settlement management system comprising:
a D/B block equipped with an authentication information database (“D/B”) containing authentication information, a sales amount collection statement information D/B containing sales amount collection statement information, a credit card sales amount prepayment information D/B containing information on the credit card sales amount prepayment, and a registration information D/B containing registration information about the relevant purchaser companies and seller companies;
a D/B management server which stores the said authentication information, sales amount collection statement information, credit card sales amount prepayment information or registration information about the seller companies and purchaser companies selectively in the relevant field of the said D/B block, or extracts the relevant information from the said D/B block;
a payment management server which: in a state connected to the said D/B management server for telecommunication, determines whether to store or extract the said authentication information, sales amount collection statement information, credit card sales amount prepayment information or registration information about the seller companies and purchaser companies; interfaces with the telecommunication clients of the seller company and the purchaser companies through the bank on-line network; and if an event for the sales amount collection management or an event for the purchase price payment management arises in telecommunication clients of a seller company or a purchaser company, analyzes systematically the said authentication information, sales amount collection statement information, credit card sales amount prepayment information or registration information about the seller companies and purchaser companies, and thereby controls and manages the settlement relationship between the relevant seller company and the purchaser company on the said bank on-line network.

2. The inter-company settlement management system according to claim 1, wherein the said bank on-line network is any network among the Internet, an automatic response system communication network, a value added network or a public switched telephone network.

3. The inter-company settlement management system according to claim 1, wherein the said payment management server further forms a telecommunication relationship with the sales amount collection statement management module which is exclusively responsible for managing the sales amount collection statements transmitted from the said seller company's telecommunication client.

4. The inter-company settlement management system according to claim 1, wherein the said payment management server further forms a telecommunication relationship with the prepayment collection management module which is exclusively responsible for managing the prepaid credit card sales amount to be collected from the said purchaser company.

5. The inter-company settlement management system according to claim 1, wherein the said payment management server further forms a telecommunication relationship with the account management module which is exclusively responsible for managing the designated accounts of the said seller companies and the said purchaser companies.

6. An inter-company settlement management method comprising the steps of:
determining whether a settlement event has occurred from any telecommunication client of a management company, which has been authenticated;
in the event that a settlement event has occurred from any of the said telecommunication client, determining whether the said management company managing the said telecommunication client is a seller company;
in the event that the said management company managing the said telecommunication client is determined to be a seller company, generating an initial page designed for a seller company and transmitting the completed initial page for a seller company to the telecommunication client of the said seller company;
determining whether an event for managing the sales amount collection statement has occurred from the said seller company's telecommunication client;
in the event that an event for managing the sales amount collection statement has occurred from the said seller company's telecommunication client, referring to the sales amount collection statement transmitted from the said seller company's telecommunication client and conducting a series of steps for managing the sales amount collection statement;
determining whether an event for requesting the credit card sales amount prepayment has occurred from the said seller company's telecommunication client; and
in the event that an event for requesting the credit card sales amount prepayment has occurred from the said seller company's telecommunication client, referring to the credit card sales amount prepayment request information transmitted from the seller company's telecommunication client and conducting a series of steps for prepaying the requested credit card sales amount.

7. The inter-company settlement management method according to claim 6, wherein the said steps for managing the sales amount collection statement comprise the steps of:
determining whether an event for transmitting the credit card sales statement has occurred from the telecommunication client of the said seller company;
in the event that an event for transmitting the credit card sales statement has occurred from the said telecommunication client of the seller company, transmitting to the said seller company's telecommunication client an input page for the credit card sales details for the inputting of the details regarding the credit card sales details;
determining whether the credit card sales statement information corresponding to the said input page for the credit card sales details has been transmitted from the said seller company's telecommunication client;
in the event that the credit card sales statement information corresponding to the said input page for the credit card sales details has been transmitted from the said seller company's telecommunication client, determining whether the inputted credit card sales statement information satisfies certain pre-determined conditions; and
in the event that the said credit card sales statement information satisfies the said conditions, collecting and storing the said credit card sales statement information.

8. The inter-company settlement management method according to claim 7, further comprising the steps of:
in the event that the said event is not for transmitting the credit card sales statement, transmitting to the said seller company's telecommunication client an input page for the account receivable details for the inputting of the details regarding the account receivable;
determining whether the account receivable statement information corresponding to the said input page for the account receivable details has been transmitted from the said seller company's telecommunication client;
in the event that the account receivable statement information corresponding to the said input page for the account receivable details has been transmitted from the said seller company's telecommunication client, determining whether the inputted account receivable statement information satisfies certain pre-determined conditions; and
in the event that the said inputted account receivable statement information satisfies the said conditions, collecting and storing the said account receivable statement information, and conducting the steps for transferring the amount of the seller company's account receivable from the purchaser company's account to the seller company's account.

9. The inter-company settlement management method according to claim 6, wherein the said steps for prepaying the credit card sales amount comprise the steps of:
transmitting to the said seller company's telecommunication client an input page for the credit card sales amount prepayment request details for the inputting of the details regarding the credit card sales amount prepayment request;
determining whether the credit card sales amount prepayment request information corresponding to the said input page for the credit card sales amount prepayment request details has been transmitted from the said seller company's telecommunication client;
in the event that the credit card sales amount prepayment request statement information corresponding to the said input page for the credit card sales amount prepayment request details has been transmitted from the said seller company's telecommunication client, determining whether the requested prepayment amount recorded in the said credit card sales amount prepayment request information is not greater than the credit balance amount of the said seller company; and
in the event that the requested prepayment amount recorded in the said credit card sales amount prepayment request information is not greater than the credit balance amount of the said seller company, prepaying the said requested prepayment amount to the said seller company.

10. The inter-company settlement management method according to claim 6, further comprising the steps of:
in the event that the management company managing the said telecommunication client is determined to be a purchaser company rather than a seller company, generating an initial page designed for a purchaser company and transmitting the completed initial page for a purchaser company to the telecommunication client of the said purchaser company;
determining whether an event of the purchase price management has occurred from the said purchaser company's telecommunication client; and
in the event that an event of the purchase price management has occurred from the said purchaser company's telecommunication client, referring to the purchase price management information transmitted from the said purchaser company's telecommunication client and conducting a series of steps for the purchase price management.

11. The inter-company settlement management method according to claim 10, wherein the said steps for the purchase price management comprise the steps of:
determining whether an event for reviewing the purchase details has occurred from the telecommunication client of the said purchaser company;
in the event that an event for reviewing the purchase details has occurred from the said telecommunication client of the purchaser company, generating the purchase details list by collecting the details regarding the said purchaser company's purchases and transmitting to the said purchaser company's telecommunication client the completed purchase details list;
determining whether an event for the credit card purchase price prepayment has occurred from the said purchaser company's telecommunication client;
in the event that an event for the credit card purchase price payment has occurred from the said purchaser company's telecommunication client, transmitting to the said purchaser company's telecommunication client an input page for the credit card purchase price prepayment details for the inputting of the details regarding the credit card purchase price details;
determining whether the credit card purchase price prepayment information corresponding to the said input page for the credit card purchase price prepayment details has been transmitted from the said purchaser company's telecommunication client; and
in the event that the credit card purchase price prepayment information corresponding to the said input page for the credit card purchase price prepayment details has been transmitted from the said purchaser company's telecommunication client, conducting a series of steps for prepaying the credit card purchase price based upon the said credit card purchase price prepayment information.

12. The inter-company settlement management system according to claim 6, after conducting the said steps for prepaying the credit card sales amount, further comprising the steps of:
determining whether the credit card sales statement contains any sales item that is due on the present day; and
in the event that the credit card sales statement contains a sales item that is due on the present day, checking the designated account of the relevant purchaser company which is related to the said credit card sales item due on the present and conducting a series of steps for managing the credit card purchase price settlement.

13. The inter-company settlement management system according to claim 12, wherein the said steps for managing the credit card purchase price settlement comprise the steps of:
determining whether the said credit card sales item that is due on the present day is subject to the prepayment collection process;
in the event that the said credit card sales item due on the present day is subject to the prepayment collection process, determining whether the amount deposited in the said purchaser company's designated account is not less than the prepaid amount of the credit card sales statement; and
in the event that the amount deposited in the said purchaser company's designated account is not less than the prepaid amount of the credit card sales statement, collecting the said prepaid amount of the credit card sales statement from the amount deposited in the said purchaser company's designated account and depositing in the seller company's designated account the relevant balance amount of the sales amount after the deduction of the said prepaid amount of the credit card sales statement.

14. The inter-company settlement management method according to claim 13, further comprising the step of collecting the remaining amount deposited in the said purchaser company's designated account and declaring the said seller company in default in the event that the amount deposited in the said purchaser company's designated account is less than the said prepaid amount of the credit card sales statement.
